(19) United States
(12) Patent Application Publication
(10) Pub. No.: US 2011/0070453 A1
(43) Pub. Date: Mar. 24, 2011

(54) LAMINATE OF TRANSPARENT CONDUCTIVE FILM

(76) Inventors: Chien-Chin Mai, Kaohsiung City (TW); Yeong-Feng Wang, Kaohsiung City (TW); Jui-Tang Yin, Kaohsiung City (TW); Chao-Hung Wang, Kaohsiung City (TW)

(21) Appl. No.: 12/563,170

(22) Filed: Sep. 21, 2009

(51) Int. Cl. B32B 18/00; C04B 35/597

(52) U.S. Cl. 428/446; 501/96.5

(57) ABSTRACT

A laminate is provided for a transparent conductive film. The transparent conductive film includes a transparent substrate that has surfaces on which a laminate composed of multiple layers is formed. The laminate has a conductive layer that has an underside to which an underside coating layer made of silicon oxy-nitride is applied so as to make the transparent conductive film showing transparency in visible light and having a b* value of color coordinates between −10≦b*≦2.5 and also reducing light reflection.

### TECHNICAL FIELD OF THE INVENTION

The present invention generally relates to a laminate of a transparent conductive film, and more particularly to a transparent conductive film applied to a resistive touch panel or a capacitive touch panel to improve the color of displaying and reduce reflectivity of light when light transmits through the transparent conductive film.

### DESCRIPTION OF THE PRIOR ART

An early conventional transparent conductive film is formed by depositing a layer of indium tin oxide (ITO) on a glass substrate, which is referred to as conductive glass. However, glass shows poor properties of flexibility and workability and is also poor in respect of impact resistance and being light weight. Thus, the transparent conductive film is now being gradually replaced by plastics, such as polyethylene terephthalate (PET).

The transparent conductive film is often used in resistive and capacitive touch panels and thus, in practical applications, transparency, deflectability, and scrape resistance are also properties of concerns. Severity of surroundings, including high humidity and high temperature, where the touch panel is used may also be factors to be handled.

The structure of the transparent conductive film that is currently available in the market includes a transparent substrate made of transparent plastics and a laminate composed of multiple layers is deposited on a surface of the substrate.

FIG. 1 of the attached drawings shows a known transparent conductive film, which is broadly designated at 1 and comprises a substrate 11 that is made of a transparent plastic material. The substrate 11 has a surface on which a laminate 12 that is composed of multiple layers is formed. The laminate 12 comprises a conductive layer 121, a rigid coating layer 122, and an adhesive layer 123. The conductive layer 121 functions to conduct electrical current therethrough and is generally made of indium tin oxide (ITO) by means of vacuum deposition, sputtering, ion plating, spray pyrolysis, chemical plating, and electroplating, or any combination of these processes, among which vacuum deposition and sputtering are preferred processes. The rigid coating layer 122, which provides protection against scraping, staining, and occurrence of Newton's rings, is preferably made of hardened resin material. The rigid coating layer 122 also offers the function of anti-glare. The substrate 11 and the rigid coating layer 122 are coupled to each other through the adhesive layer 123.

Generally speaking, the electrical resistance of the currently available resistive and capacitive touch panels is around 100 Ω/μm to 600 Ω/μm. The conductive layer 121 of the transparent conductive film 1 usually has a thickness ranging from 15 nm to 75 nm. Under these conditions, as shown in FIG. 2, which provides color distribution in CIE Lab color system, when the thickness of the conductive layer 121 exceeds 10 nm, the b* value of the color coordinates gets greater than 1, meaning the color of the light transmitting through the transparent conductive film 1 gets significant change. As illustrated in FIG. 2, it can be found that the commonly used thickness of the conductive layer 121, which ranges from 15 nm to 75 nm, may result in a b* value between 1 to 4, making the conductive layer 121 biased to yellow color. As shown in FIG. 3, the currently available substrate 11 that is provided with a rigid coating layer 122 has a b* value of the color coordinates between around 0.2 to 0.9. Thus, a completed product of the transparent conductive film 1 would show a b* value greater than 2. In other words, after passing through the transparent conductive film 1, light would show biasing toward yellow color.

The manufacturers of resistive and capacitive touch panels set a requirement that the b* value be smaller than 3 to the suppliers of transparent conductive films. However, for high-end products, even smaller color deviation is required for the displays of these products and may sometimes need the displaying of the display devices to be blue biased, meaning the b* value of the color coordinates be −10≦b*≦2.5. This is now becoming a trend in this industry for making better products.

Further, as shown in FIG. 4, concerning the refractivity of the laminate 12 of the transparent conductive film 1, the ITO-based conductive layer 121 shows the highest refractive index and a greater difference of refractive index is present between junction surfaces 1211, 1212 of the conductive layer 121 that serve to provide electrical contact. Since the surfaces 1211, 1212 of the conductive layer 121 are provided for electrical contact, additional processing or treatment for eliminating light reflection is not allowed to directly carry out thereon, so that there always exists significant light reflection. This cannot be properly handled heretofore and is a major challenge to the industry.

### SUMMARY OF THE INVENTION

The present invention provides a laminate for a transparent conductive film. The transparent conductive film comprises a substrate made of plastics. A laminate formed of multiple layers including a conductive layer, a rigid coating layer, an adhesive layer, and an underside coating layer is set on a surface of the substrate. The conductive layer of the laminate is generally made of indium tin oxide (ITO) having a thickness from 15 nm to 75 nm. The rigid coating layer provides protection against scraping, staining, and occurrence of Newton's rings and is made of hardened resins. The rigid coating layer also offers a function of anti-glare. The substrate and the rigid coating layer are coupled together through the adhesive layer.

The underside coating layer of the transparent conductive film in accordance with the present invention is generally made of a material of silicon oxy-nitride (SiOxNy). Properly adjusting the fractions of nitrogen and silicon contained in the material of silicon oxy-nitrogen can make the transparent conductive film showing excellent transparency in the visible light zone and having a b* value of color coordinates between −10≦b*≦2.5 and also reducing light reflection, so as to make it showing a white color or blue biased color.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a conventional transparent conductive film.

FIG. 2 shows CIE Lab color system diagram for thickness/color coordinates of a conductive layer.

FIG. 3 shows tables of b* values for substrates carrying a rigid coating layer that are currently available in the market.

FIG. 4 is a schematic view illustrating refractivity of each layer of a laminate of a conventional transparent conductive film.

FIG. 5 is a schematic view showing a transparent conductive film in accordance with the present invention.

FIG. 6 is a schematic view showing another transparent conductive film in accordance with the present invention.

FIG. 7 is a plot of a color-matching function of RGB color system of visible light.

FIG. 8 is a UV-visible transmission spectrum of silicon oxy-nitride.

FIG. 9 is a plot showing the relationship between component ratio of silicon oxy-nitride and refractivity.

FIG. 10 is a plot showing the relationship between an underside coating layer of the present invention and interface refractivity.

FIG. 11 is a table of data that establish the plot of FIG. 10.

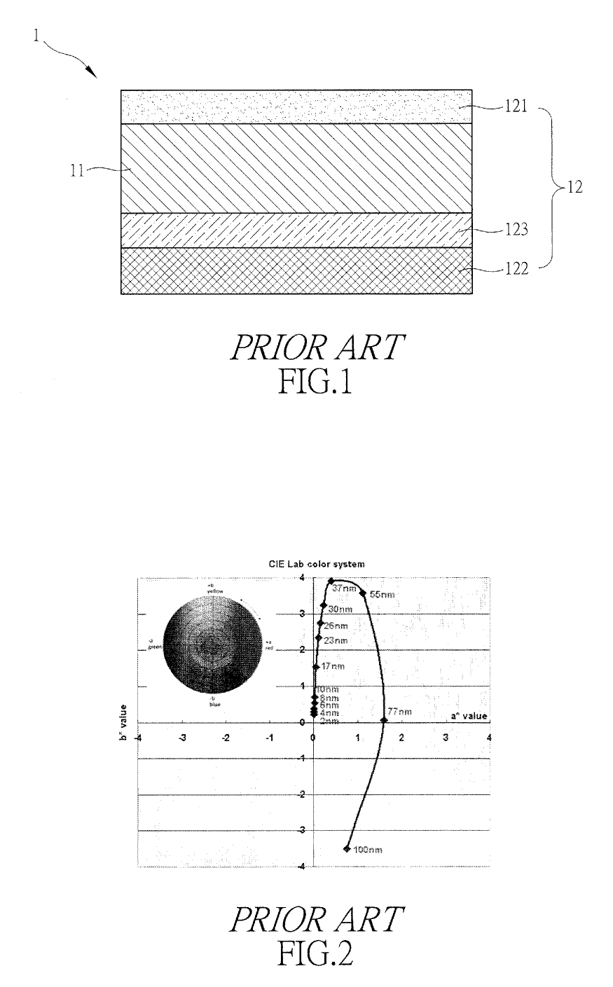

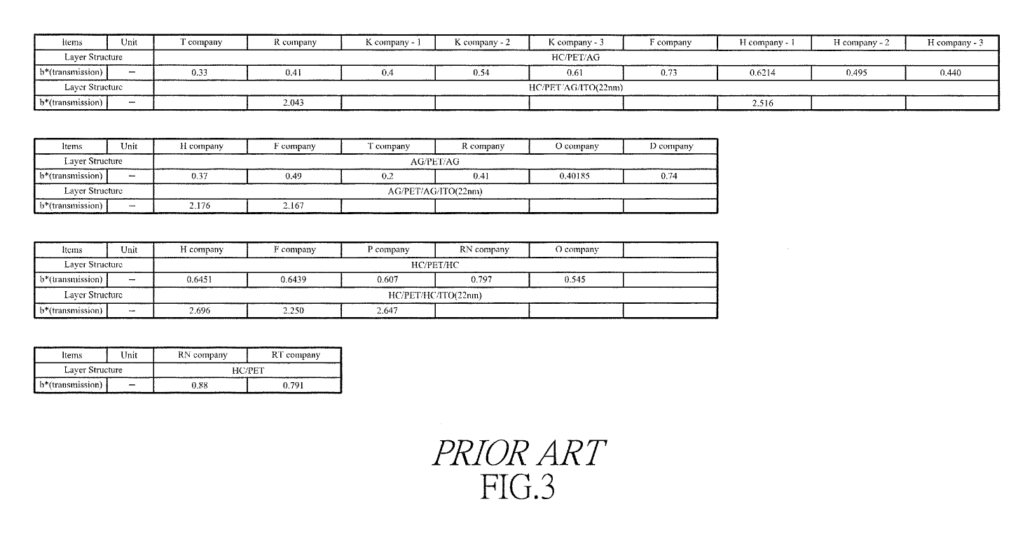

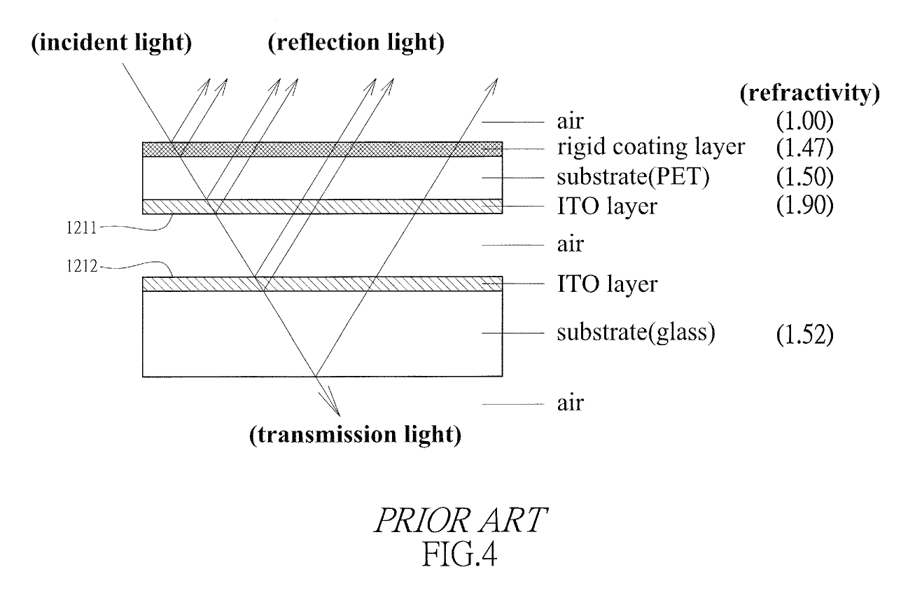

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

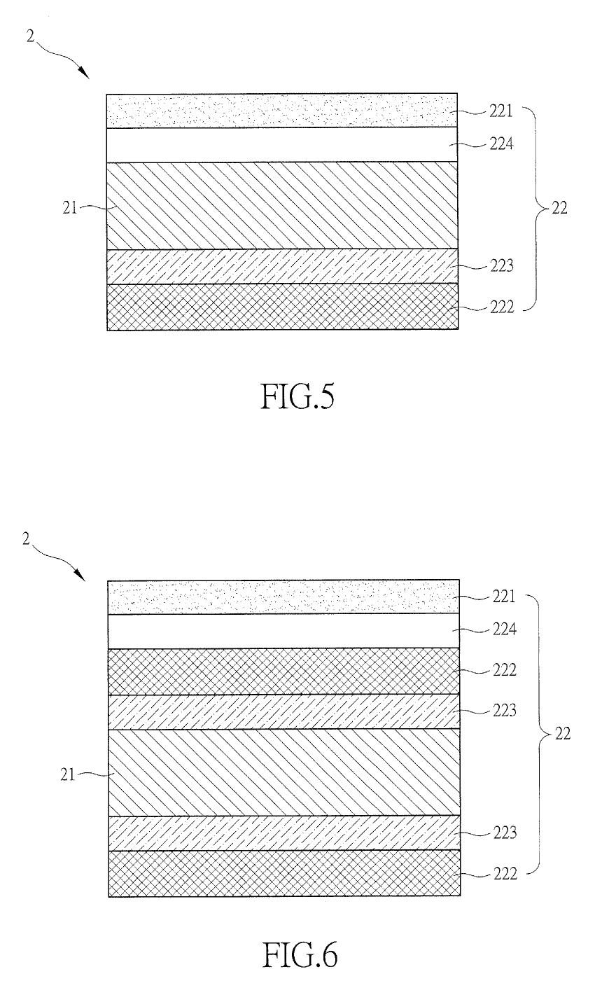

The present invention provides a transparent conductive film for a touch panel, as shown in FIG. 5. The transparent conductive film 2 comprises a substrate 21 made of a transparent material and having surfaces on which laminates 22 composed of multiple layers are formed. The material that makes the substrate 21 is not limited to any specific material and preferably comprises plastics including polyethylene terephthalate (PET), having a thickness between 2 μm to 300 μm, preferably between 10 μm to 188 μm. The multiple layers of the laminates 22 preferably include a conductive layer 221, a rigid coating layer 222, and an adhesive layer 223. The conductive layer 221 functions to conduct electrical current therethrough and is composed of ITO as a major constituent material. The conductive layer 221 has a thickness ranging from 15 nm to 75 nm. The adhesive layer 223 is interposed between the substrate 21 and the rigid coating layer 222 to bridge and couple between the substrate 21 and the rigid coating layer 222. The adhesive layer 223 is generally composed of a transparent adhesive substance and is preferably composed of materials of hardened resin, including melamine resin, urethane resin, alkyd resin, acrylic resin, and silicone resin. An underside coating layer 224 is arranged between the conductive layer 221 of the laminate 22 and the substrate 21 and the underside coating layer 224 is generally made of a material of silicon oxy-nitride (SiOxNy). As shown in FIG. 6, to enhance the mechanical performance of the transparent conductive film 2, an additional laminate 22 composed of a rigid coating layer 222 and a adhesive layer 223 can be further set between the underside coating layer 224 and the substrate 21.

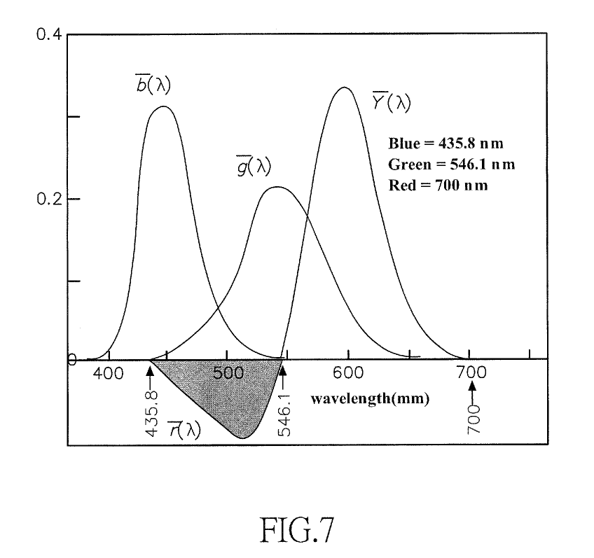

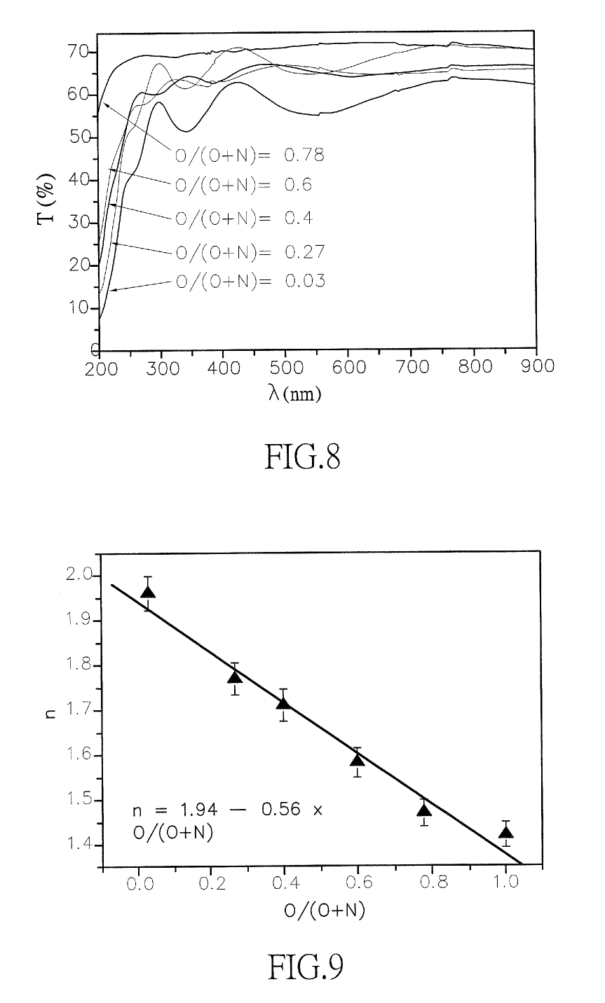

Referring to FIG. 7, the visible light has a wavelength ranging between 380 nm to 760 nm and blue light wavelength is around 435.8 nm. Also referring to FIG. 8, the underside coating layer 224, which is made of the material of silicon oxy-nitride, can be made to show high transmittance for blue light of 435.8 nm wavelength by adjusting the fractions of nitrogen and silicon contained in the material of silicon oxy-nitride, making b*≦0, which shows a blue-biased color. This helps to set the b* value of color coordinates of the whole transparent conductive film 2 in the range: −10≦b*≦2.5, lessening color deviation or making the color slightly biased toward blue.

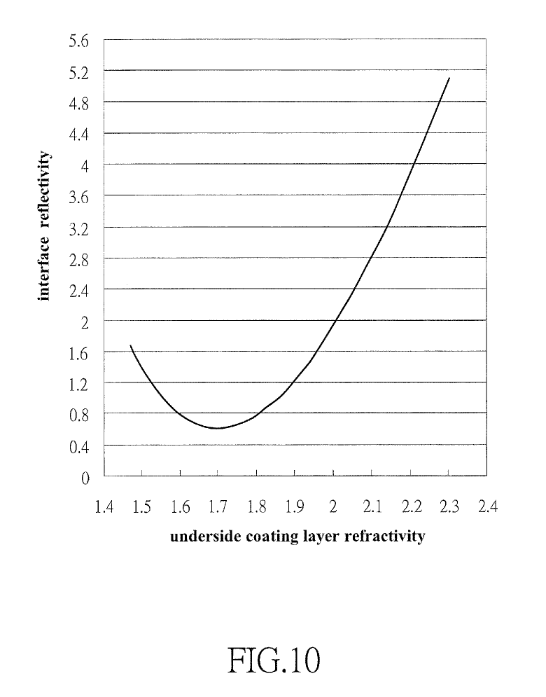

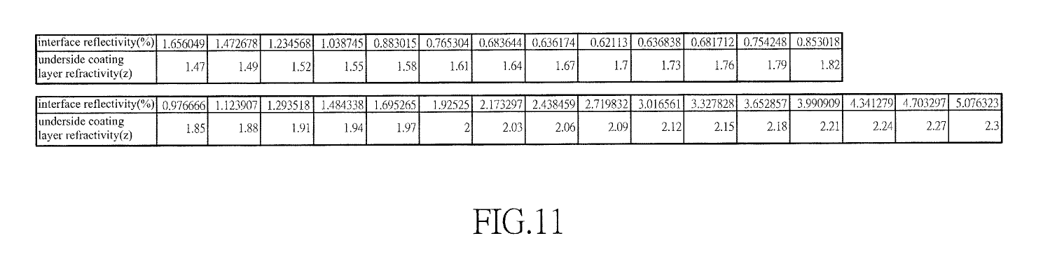

Referring to FIG. 9, the ratio of the fractions of nitrogen and oxygen contained in silicon oxy-nitride shows a significant influence on light refraction. When adjustment is made to the ratio between nitrogen and oxygen contained in silicon oxy-nitride, the refraction of light is also adjusted. In other words, by properly adjusting the fractions of the constituent elements of the material of silicon oxy-nitride that makes the underside coating layer 224, the refractivity/reflectivity of the transparent conductive film 2 with respect to light can be changed. The relationship between reflectivity and refractivity of the underside coating layer 224 that is obtained through conduction of experiments is shown in FIGS. 10 and 11, and it can be seen that adjusting the refractivity to 1.7 would make the reflectivity 0.62%. Preferred fractions of nitrogen and oxygen of the material of silicon oxy-nitride (SiOxNy) satisfy the formula: 2X(oxygen)+3Y(nitrogen)=4, wherein the value of X for oxygen is set as follows: 0≦X≦2 and the value of Y for nitrogen is set as follows: 0≦Y≦4/3.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A laminate for a transparent conductive film, adapted to be set on a surface of a substrate, the laminate comprising at least an underside coating layer that is made of a material of silicon oxy-nitride (SiOxNy), the underside coating layer being applied to an underside of a conductive layer of the laminate.

2. The laminate according to claim 1, wherein the underside coating layer has a bottom set on the substrate.

3. The laminate according to claim 1, wherein the underside coating layer has a bottom that is provided sequentially with a rigid coating layer and an adhesive layer, which are set on the substrate.

4. The laminate according to claim 1, wherein the material of silicon oxy-nitride having chemical formula of SiOxNy comprises nitrogen and oxygen that have fractions satisfying the formula: 2X+3Y=4, wherein X indicates the fraction of oxygen and Y indicates the fraction of nitrogen, and wherein X and Y satisfy the following conditions: 0≦X≦2 and 0≦Y≦4/3.
